(19) United States
(12) Patent Application Publication
(10) Pub. No.: US 2026/0354294 A1
(43) Pub. Date: Nov. 12, 2026

(54) CONNECTION SYSTEM FOR WINGS OF A FOLDABLE AGRICULTURAL IMPLEMENT

(71) Applicant: BOURGAULT INDUSTRIES LTD., St. Brieux (CA)

(72) Inventors: Kyle Bayne, Saskatoon (CA); Warren Becker, Saskatoon (CA); Robert Klenz, Saskatoon (CA)

(21) Appl. No.: 19/202,460

(22) Filed: May 8, 2025

(51) Int. Cl. A01B 73/04

(52) U.S. Cl. CPC A01B 73/046

(57) ABSTRACT

A connection system for connecting together a first wing and a second wing of a foldable agricultural implement includes a hinge mechanism and an isolation joint. The hinge mechanism has a hinge link pivotably coupled to the first and second wings at first and second hinge axes for moving the second wing between unfolded and folded positions. The isolation joint includes a first arm with a pivot slot and a second arm with a pivot member, and is movable between a disengaged position in which the pivot member is spaced apart from the pivot slot to facilitate folding, and an engaged position in which the pivot member is seated in the pivot slot when the second wing is in the unfolded position to isolate the hinge mechanism from forces urging portions of the wings laterally toward or apart from one another during use of the implement.

### FIELD

The teaching disclosed herein relates to agricultural implements, and in particular to a connection system for connecting together two wings of a foldable agricultural implement.

### INTRODUCTION

U.S. Pat. No. 8,122,970 (Palen) purports to disclose a duplex hinge having two pivot points. In one embodiment, the hinge is used between sections of multi-sectional farm implements to allow flex during field operations as well as folding for road transport. One pivot point is active both when folding and during field operations. The other pivot point is active during field operations but rigid while folding for road transport.

U.S. Pat. No. 8,468,655 (Borkgren) purports to disclose a hinge assembly with two pivot axes for a folding frame. One pivot axis, a working pivot axis, allows the outer wing frame to rotate while in operation to follow the ground contours by rotating relative to the adjacent frame section without creating any interference between adjacent tools mounted to the frame sections. The second pivot axis is a folding pivot axis above the frame and about which the outer wing frame rotates to fold the outer wing into the transport position. This hinge assembly when used on a five section implement frame allows the outer wing frame to both follow the ground contour and to fold into an acceptable transport position.

U.S. Pat. No. 9,462,739 (Naylor) purports to disclose an agricultural implement that includes a compound hinge arrangement that allows for compact folding adjacent frame segments such as wing segments of planting, seeding, or tillage implements. The compound hinge arrangement includes a first pivot axis that can be active when the implement is in an unfolded field-use position in which a second pivot axis of the compound hinge arrangement is locked. The implement may be folded into a folded transport position by pivoting an outer wing about the first pivot axis with a first actuator during a first stage and pivoting the compound hinge arrangement and the outer wing about the second pivot axis during a second stage.

U.S. Pat. No. 9,554,501 (Sudbrink) purports to disclose a folding agricultural implement including a center frame section, a plurality of wing sections and first and second hinge systems. The plurality of wing sections are positioned on opposite lateral sides of the center frame section, and include an inner wing section, a middle wing section and an outer wing section, each outer wing section being configured to fold laterally inward and over a respective middle wing section. Each middle wing section is configured to fold laterally inward and over a respective inner wing section. The first hinge system is coupled to both the outer wing section and the middle wing section. The first hinge system having a first pivot axis. The second hinge system is coupled to the middle wing section and the inner wing section, and has a second pivot axis that is vertically higher than the first pivot axis when the implement is in an unfolded state

### SUMMARY

The following summary is intended to introduce the reader to various aspects of the applicant's teaching, but not to define any invention.

In one aspect, a connection system for connecting together a first wing and a second wing of a foldable agricultural implement includes a) a hinge mechanism and b) an isolation joint. The hinge mechanism includes a hinge link coupled to the first wing about a longitudinally extending first hinge axis and coupled to the second wing about a longitudinally extending second hinge axis. The second wing is pivotable about the first and second hinge axes for moving the second wing between an unfolded position in which the second wing is laterally adjacent the first wing for use of the implement, and a folded position in which the second wing overlaps the first wing to facilitate transport of the implement. One of the first hinge axis and the second hinge axis defines a field axis and another, different one of the first hinge axis and the second hinge axis defines a transport axis. The second wing is pivotable relative to the first wing about the field axis when the second wing is in the unfolded position and the implement is in use to facilitate following field contours. The isolation joint includes a first arm fixed to one of the first wing and the second wing, and a second arm fixed to an other, different one of the first wing and the second wing, such that each of the first wing and the second wing has one of the first arm and the second arm fixed thereto. The first arm includes a pivot slot, and the second arm includes a pivot member secured to the second arm. The isolation joint is movable between a disengaged position in which the pivot member is spaced apart from the pivot slot when the second wing is in the folded position to facilitate folding of the implement, and an engaged position in which the pivot member is seated in the pivot slot and in coaxial alignment with the field axis when the second wing is in the unfolded position to isolate the hinge mechanism from forces urging adjacent portions of the first and second wings laterally toward or apart from one another during use of the implement. In some examples, the first hinge axis is fixed relative to the first wing. In some examples, the second hinge axis is fixed relative to the second wing.

In some examples, the pivot slot extends between a pivot slot open end and a pivot slot closed end, the pivot slot open and closed ends spaced apart along a pivot slot arc that is concentric with the transport axis when moving the pivot member relative to the pivot slot between the pivot slot open and closed ends. In some examples, the first arm is fixed to the first wing and the second arm is fixed to the second wing. In some examples, the pivot slot is fixed relative to the field axis, and the pivot member is receivable in the pivot slot when the second wing is moved from the folded position to the unfolded position.

In some examples, one of the first and second arms further includes a retaining slot, and another, different one of the first and second arms includes a retaining member secured thereto. The retaining member is receivable in the retaining slot when the pivot member is seated in the pivot slot. Engagement of the retaining member with a sidewall of the retaining slot contributes to at least one of (i) said isolating of the hinge mechanism from said forces, and (ii) inhibiting withdrawal of the pivot member from the pivot slot.

In some examples, when the pivot member is in the engaged position, the retaining member is movable relative to the retaining slot between a coupled position within the retaining slot and an uncoupled position spaced apart from the retaining slot by pivoting the second wing about the field axis.

In some examples, the retaining slot extends between a retaining slot open end and a retaining slot closed end, the retaining slot open and closed ends spaced apart along a retaining slot arc that is concentric with the field axis when moving the retaining member relative to the retaining slot between the retaining slot open and closed ends. In some examples, the second arm is the retaining slot, and the first arm is the retaining member secured thereto.

In some examples when the implement is unfolded for use, pivoting of the second wing relative to the first wing about the field axis within a contour pivot range corresponds to relative movement of the retaining member in the retaining slot between the retaining slot open end and the retaining slot closed end. In some examples the pivot member, when in the engaged position, defines an isolation joint pivot axis that is colinear with the field pivot axis. In some examples, the second wing is pivotable about the field axis by about 90 degrees. In some examples the hinge link is pivotable about the transport axis by about 90 degrees.

In some examples, the connection system includes two isolation joints spaced longitudinally apart from one another, including a front isolation joint proximate a front of the first and second wings, and a rear isolation joint proximate a rear of the first and second wings. In some examples, the connection system includes two hinge mechanisms spaced longitudinally apart from one another. In some examples, the two hinge mechanisms are disposed longitudinally between the front and rear isolation joints.

In another aspect, a connection system for connecting together a first wing and a second wing of a foldable agricultural implement includes a) a hinge mechanism and b) an isolation joint. The hinge mechanism includes a hinge link coupled to the first wing about a longitudinally extending first hinge axis and coupled to the second wing about a longitudinally extending second hinge axis. The second wing is pivotable about the first and second hinge axes for moving between an unfolded position in which the second wing is laterally adjacent the first wing for use of the implement, and a folded position in which the second wing overlaps the first wing to facilitate transport of the implement. One of the first hinge axis and the second hinge axis defines a field axis and another, different one of the first hinge axis and the second hinge axis defines a transport axis. The second wing is pivotable relative to the first wing about the field axis when the second wing is in the unfolded position and the implement is in use to facilitate following field contours. The isolation joint includes a first arm fixed to one of the first wing and the second wing, and a second arm fixed to an other, different one of the first wing and the second wing such that each of the first wing and the second wing has one of the first arm and the second arm fixed thereto. The first arm includes a retaining slot, and the second arm includes a retaining member secured to the second arm. The isolation joint is movable between a disengaged position in which the retaining member is spaced apart from the retaining slot when the second wing is in the folded position to facilitate folding of the implement, and an engaged position in which the retaining member is disposed within the retaining slot when the second wing is in the unfolded position to isolate the hinge mechanism from forces urging adjacent portions of the first and second wings laterally toward or apart from one another during use of the implement.

In some examples, the retaining slot extends between a retaining slot open end and a retaining slot closed end, the retaining slot open and closed ends spaced apart along a retaining slot arc that is concentric with the field axis when moving the retaining member relative to the retaining slot between the retaining slot open and closed ends.

In some examples, when the implement is unfolded for use, pivoting of the second wing relative to the first wing about the field axis within a contour pivot range corresponds to relative movement of the retaining member in the retaining slot between the retaining slot open end and the retaining slot closed end.

Other aspects and features of the teachings disclosed herein will become apparent to those ordinarily skilled in the art, upon review of the following description of the specific examples of the present disclosure.

### DRAWINGS

For a better understanding of the described examples and to show more clearly how they may be carried into effect, reference will now be made, by way of example, to the accompanying drawings in which:

FIG. 1 is a top front perspective view of an example agricultural implement according to aspects of the teaching disclosed herein, the implement in an unfolded position;

FIG. 2 is a front view of a portion of the implement of FIG. 1;

FIG. 3 is an enlarged perspective view of a connection system of the implement of FIG. 2, for connecting a first wing to a second wing;

FIG. 4 is a front view of a portion of the implement of FIG. 2, with an outer wing showing in a folded position;

FIG. 5 is a front view of the portion of the implement of FIG. 4, with the second wing in an intermediate (partly-folded) position;

FIG. 6 is a front view of the portion of the implement of FIG. 5, with the second wing folded further than in the position of FIG. 5;

FIG. 7 is a facing view of the portion of the implement of FIG. 6, with the second wing in the folded position;

FIG. 8 is front view of the implement of FIG. 1, in a folded position;

FIG. 9 is an enlarged front view of the connection system of FIG. 3;

FIG. 10 is an exploded front right perspective view of an isolation joint of the connection system of FIG. 9;

FIG. 11 is an expanded front view of the isolation joint of FIG. 10;

FIG. 12 is a front-left perspective view of a right portion of the isolation joint of FIG. 10;

FIG. 13 is a front-right perspective view of a left portion of the isolation joint of FIG. 10;

FIGS. 14a and 14b are front views of a portion of the connection structure of FIG. 3 showing the first and second wings pivoted relative to each other at different angles within a contour pivot range;

FIG. 15 is a front view of a portion of another agricultural implement according to aspects of the teaching disclosed herein, with an outer wing in a folded position;

FIG. 16 is an enlarged front view of a connection structure portion of the implement of FIG. 15;

FIG. 17 is a front view of the implement of FIG. 15 with the second wing in an intermediate (partly-folded) position;

FIG. 18 is a front view of the implement of FIG. 15, with the second wing in the folded position;

FIG. 19 is an enlarged front view of another connection structure for an agricultural implement according to aspects of the teaching disclosed herein;

FIG. 20 is an enlarged front view of another connection structure for an agricultural implement according to aspects of the teaching disclosed herein; and

FIG. 21 is an enlarged front view of another connection structure for an agricultural implement according to aspects of the teaching disclosed herein.

The drawings included herewith are for illustrating various examples of apparatuses and methods of the teaching of the present specification and are not intended to limit the scope of what is taught in any way.

### DETAILED DESCRIPTION

Various apparatuses or processes will be described below to provide an example of each claimed invention. No example described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an example of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

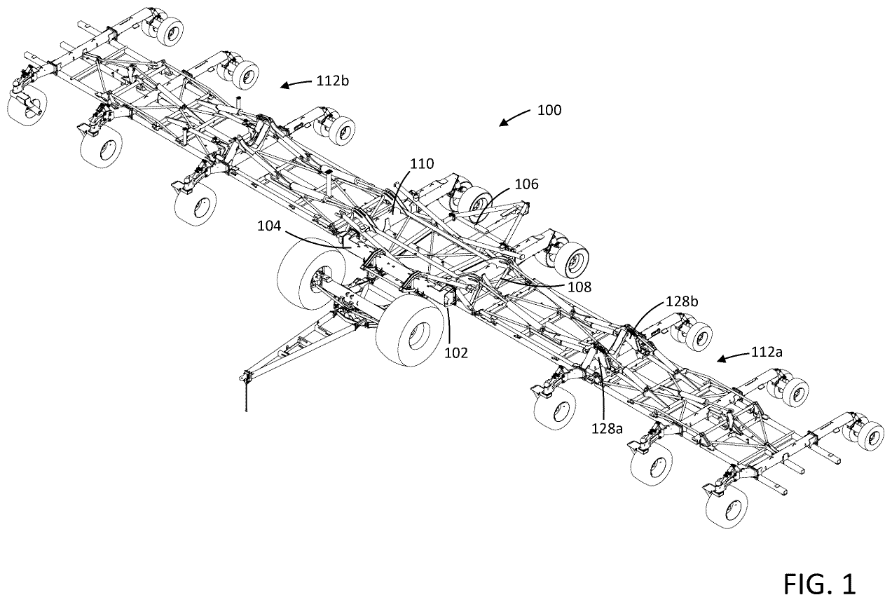

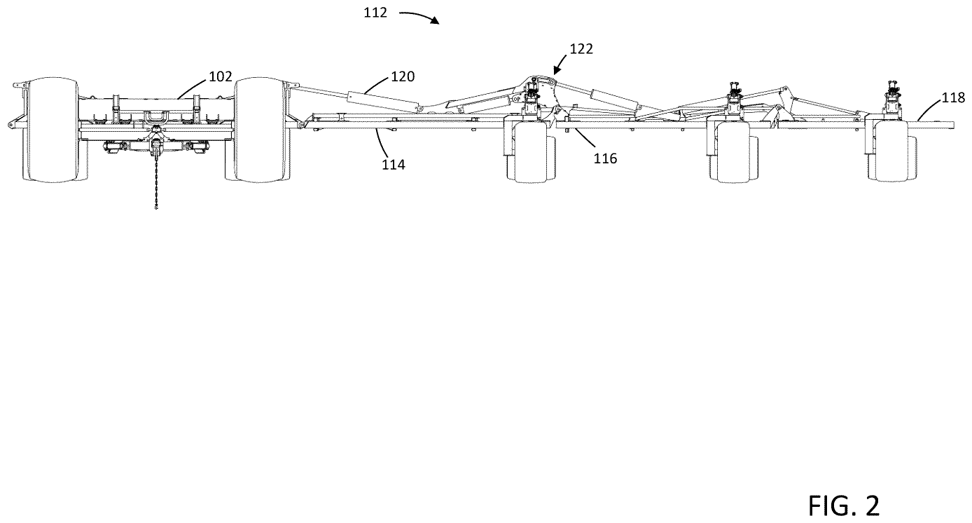

Referring to FIGS. 1 and 2, an agricultural implement 100 towable behind a vehicle includes a main frame 102 extending longitudinally between a main frame front 104 and a main frame rear 106, and extending laterally between a main frame left side 108 and a main frame right side 110 (the sides oriented relative to the direction of travel). The agricultural implement is, in the example illustrated, foldable, and includes a folding left-wing assembly 112a coupled to the main frame left side 108, and a folding right-wing assembly 112b coupled to the main frame right side 110.

The left-and right-wing assemblies 112a, 112b are, in the illustrated example, symmetrical to one another about a longitudinally extending centerline of the implement, and for simplicity further details are described with respect to one of the wing assemblies 112a, 112b identified generically as a wing assembly 112. The wing assembly 112, in the example illustrated, includes an inner wing 114 (FIG. 2) pivotably coupled to the main frame 102, a middle wing 116 pivotably coupled to the inner wing 114, and an outer wing 118 pivotably coupled to the middle wing 116. Actuators 120 are provided, in the illustrated example, to pivot each of the inner wing, middle wing, and outer wings with respect to one another for folding and unfolding the implement.

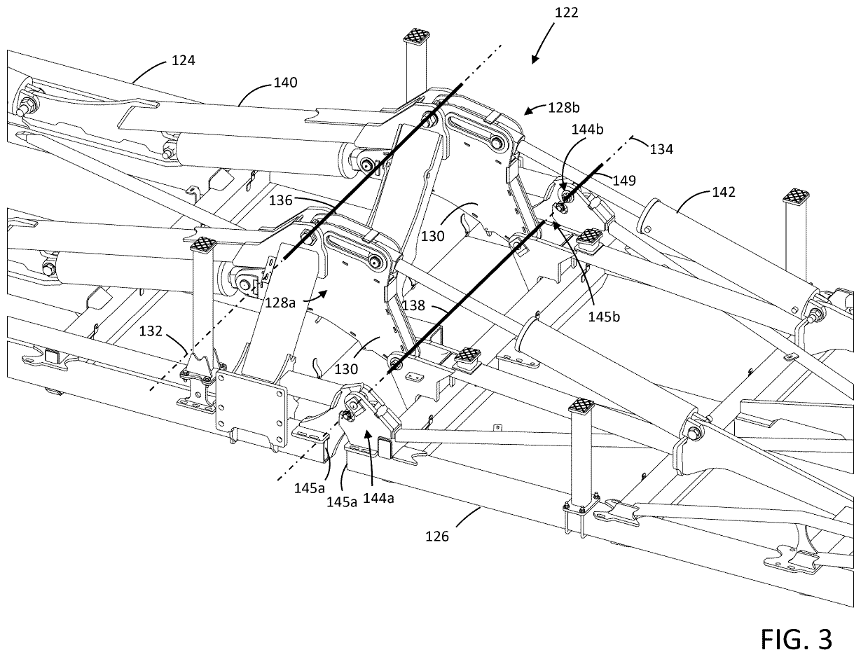

Referring to FIG. 3, the agricultural implement 100 further includes a connection system 122 for connecting together a first wing 124 and a second wing 126 of the foldable agricultural implement. The first wing and second wing may be any two adjacent wings of the inner wing 114, the middle wing 116, and the outer wing 118. In the example illustrated, the first wing 124 is the inner wing 114, and the second wing 126 is the middle wing 116 such that the connection system 122 connects together the inner wing 114 and the middle wing 116.

The connection system 122 includes a hinge mechanism 128 that pivotably couples together the first wing 124 and the second wing 126. In the example illustrated the connection system 122 includes two hinge mechanisms, namely a front hinge mechanism 128a and a rear hinge mechanism 128b spaced longitudinally apart from one another. In other examples the connection system 122 may include a single hinge mechanism or more than two hinge mechanisms.

In the example illustrated, the front and rear hinge mechanisms 128a, 128b are of common construction, either one of which is identified generically as a hinge mechanism 128. Each hinge mechanism 128 is, in the example illustrated, a compound hinge having two hinge axes 132, 134 spaced apart from one another. More particularly, the hinge mechanism 128 includes a hinge link 130 that is pivotably coupled to the first wing 124 at a first hinge axis 132 and that is pivotably coupled to the second wing 126 at a second hinge axis 134. The first hinge axis 132 and the second hinge axis 134 extend in the longitudinal direction and are parallel to one another.

The second wing 126 is pivotable about the first and second hinge axes 132, 134 for moving the second wing 126 between an unfolded position and a folded position. In the unfolded position, the second wing 126 is laterally adjacent the first wing 124 for use of the implement. In the folded position, the second wing 126 overlaps the first wing 124 to facilitate transport of the implement.

One of the first and second longitudinally extending hinge axes 132, 134 defines a field axis and another, different one of the first and second hinge axes 132, 134 defines a transport axis. The second wing 126 is pivotable relative to the first wing 124 about the field axis when the second wing is in the unfolded position and the implement is in use to facilitate following field contours. In the example illustrated, the second hinge axis 134 defines a field axis, and the first hinge axis 132 defines a transport axis. In the example illustrated, the longitudinally extending first hinge axis 132 (transport axis) is fixed relative to the first wing 124, and the longitudinally extending second hinge axis 134 (field axis) is fixed relative to the second wing 126. The transport axis 132, spaced apart from the field axis 134, facilitates folding the wings of the implement in an overlapping, interlaced configuration, which in turn helps decrease the width and height dimensions of the implement when folded. This can facilitate safe transport of the implement on roadways with other traffic, and beneath overpasses, etc.

To unfold and fold the wing assembly 112, the actuators 120 include, in the example illustrated, a first actuator 140 adapted to pivot the hinge link 130 relative to the first wing 124 about the transport axis 136, and a second actuator 142 adapted to pivot the second wing 126 relative to the hinge link 130 about the field axis 138. The second wing 126 and the hinge link 130 are pivotable about both of the first hinge axis 132 and second hinge axis 134 between an unfolded position, in which the second wing 126 is laterally adjacent the first wing 124; and a folded position, in which the second wing 126 overlaps the first wing 124.

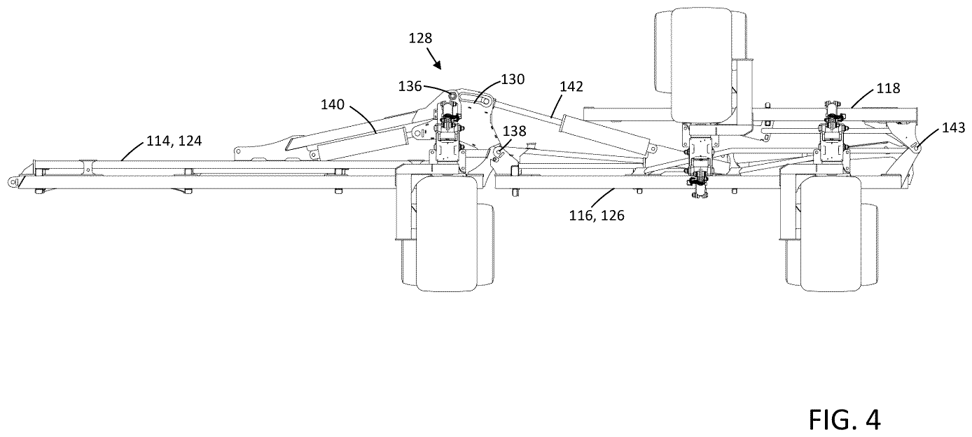

Referring to FIGS. 4-8, an example sequence of moving the implement from the unfolded position to the folded position is described as follows. The sequence of the illustrated example includes moving the outer wing 118 from an unfolded position (FIG. 2), laterally adjacent the middle wing 116, to a folded position (FIG. 4), overlapping the middle wing 116. In the example illustrated, the outer wing 118 pivots approximately 180 degrees about a single outer hinge axis 143.

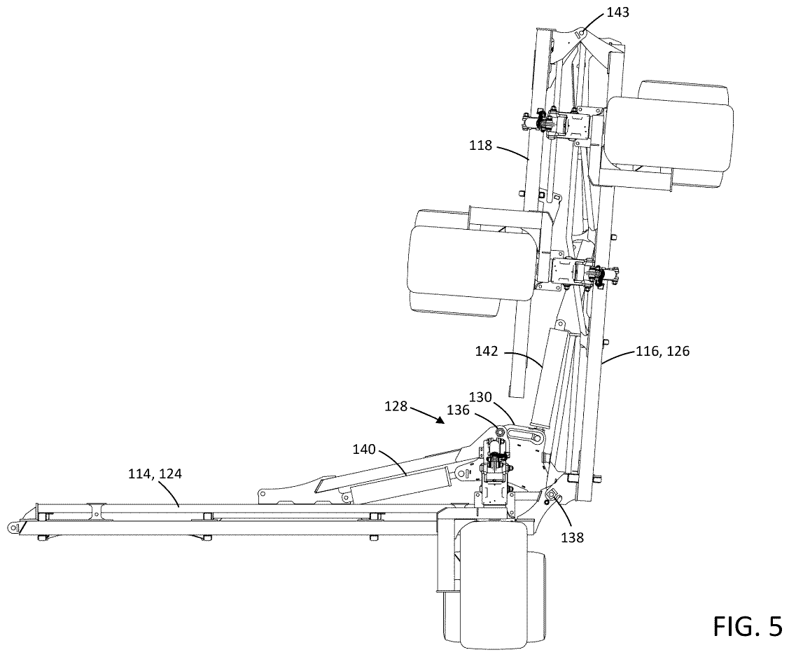

The example sequence for folding the wing assembly 112 further includes pivoting the second wing 126 (which is the middle wing 116, in the example illustrated) about the field axis 138, from the unfolded position (FIG. 4) to an intermediate or partly-folded position (FIG. 5). In the example illustrated, the intermediate position is defined by a wing raised position in which the second wing 126 (with the outer wing 118 folded thereon) is pivoted to an upright orientation relative to the first wing 124 (which is the inner wing 114 in the illustrated example). In the example illustrated, moving the second wing 126 to the intermediate position includes contracting the second actuators 142, to pivot the second wing 126 approximately 90 degrees about the field axis 138.

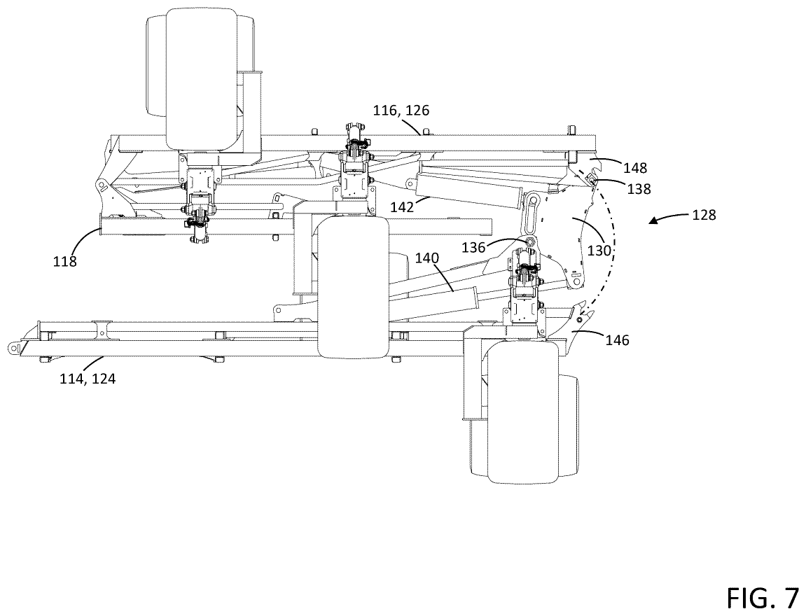

The example sequence for folding the wing assembly 112 further includes pivoting the second wing 126 about the transport axis 136 from the intermediate position (FIG. 5) to the folded position (FIG. 7). When in the folded position, in the example illustrated, the second wing 126 overlaps the first wing 124, with the outer wing 118 sandwiched between the first and second wings 124, 126. In the example illustrated, moving the second wing 126 from the intermediate position to the folded position includes extending the first actuators 140, to pivot the second wing 126 approximately 90 degrees about the transport axis 136.

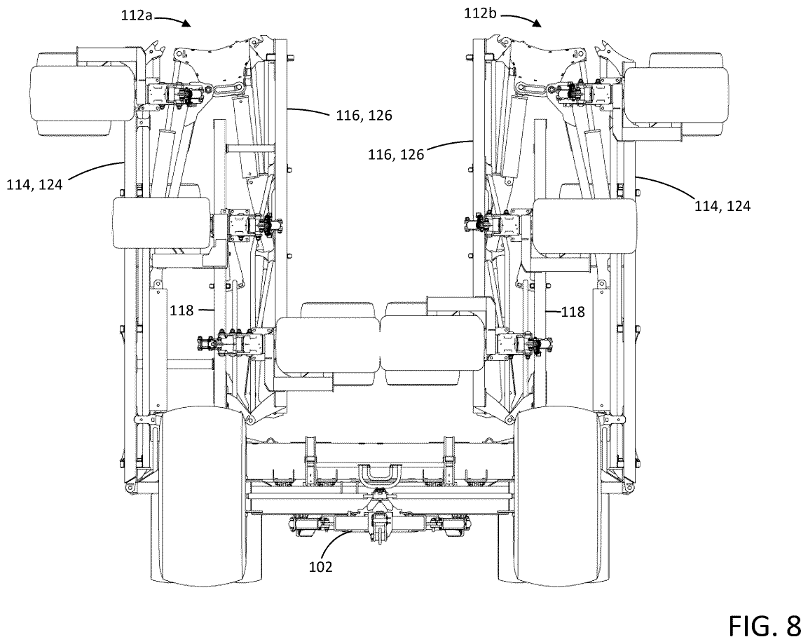

The example sequence for folding the wing assembly 112 further includes pivoting the first wing 124 (with the second wing 126 and the outer wing 118 folded in an overlapping configuration thereon) about an inner pivot axis to a folded position (FIG. 8). In the example illustrated, when in the folded position, the first wing 124 is in an upright orientation, with the second wing 126 and the outer wing 118 also in an upright orientation, laterally inboard of, and in an overlapping configuration with, the first wing 124. To unfold the wing assembly 112 the process may be generally reversed.

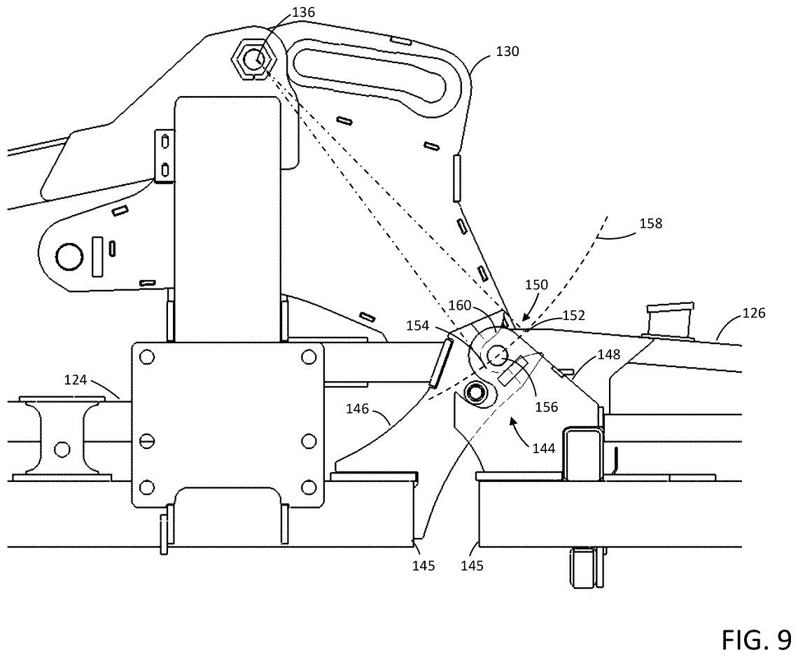

Referring to FIG. 9, the connection system 122 further includes an isolation joint 144 to resist or take up forces that would otherwise be borne by other components of the implement, for example, the hinge mechanism 128. These forces can include forces tending to laterally push together or pull apart adjacent portions 145 of the first and second wings 124, 126. Such forces can include forces caused by draft forces that resist forward movement of the implement as the implement is moved across the field during use.

For example, draft forces acting opposite to the direction of travel, and at a laterally outboard point on the second wing 126, generate a horizontally rearward force that urges the laterally outboard end of the second wing 126 further rearward than the laterally inner end of the second wing 126. This in turn can urge a pair of rear adjacent portions 145b of the adjacent portions 145 laterally toward one another (wherein the rear adjacent portions 145b include an inboard rear adjacent portion 145b at the rear of the second wing 126 and an outboard rear adjacent portion 145b at the rear of the first wing 124). At the same time, this force can urge a pair of front adjacent portions 145a of the adjacent portions 145 laterally apart from one another (wherein the front adjacent portions 145a include an inboard front adjacent portion 145a at the front of the second wing 126 and an outboard front adjacent portion 145a at the front of the first wing 124. Thus the draft forces can generate lateral forces that urge adjacent portions of the first and second wings 124, 126 laterally toward or apart from one another. In some examples, lateral forces urging adjacent portions of the first and second wings 124, 126 laterally toward one another or apart from one another can alternatively or additionally result from other factors, such as, for example, turning the implement one way or the other at the end of a row or operating the implement along uneven terrain.

Providing the implement with one or more isolation joints 144 can help isolate components of the implement from the forces urging the first and second wings toward or apart from one another, particularly components associated with pivotal attachment of the wings of the folding wing assemblies, such as the hinge mechanisms 128.

In the example illustrated, the connection system 122 includes two isolation joints 144 spaced longitudinally apart from one another. The two isolation joints comprise a front isolation joint 144a (FIG. 3) proximate the front of the first wing 124 and second wing 126, and a rear isolation joint 144b proximate a rear of the first wing 124 and second wing 126. In other embodiments, the connection system 122 may include a single isolation joint or may include more than two isolation joints.

Referring again to FIG. 9, each isolation joint includes a first arm 146 fixed to one of the first and second wings 124, 126 and a second arm 148 fixed to the other (different) one of the first and second wings 124, 126 such that each of the first wing 124 and the second wing 126 has one of the first arm 146 and the second arm 148 fixed thereto. In the example illustrated, the first arm 146 is fixed to the first wing 124 and the second arm 148 fixed to the second wing 126.

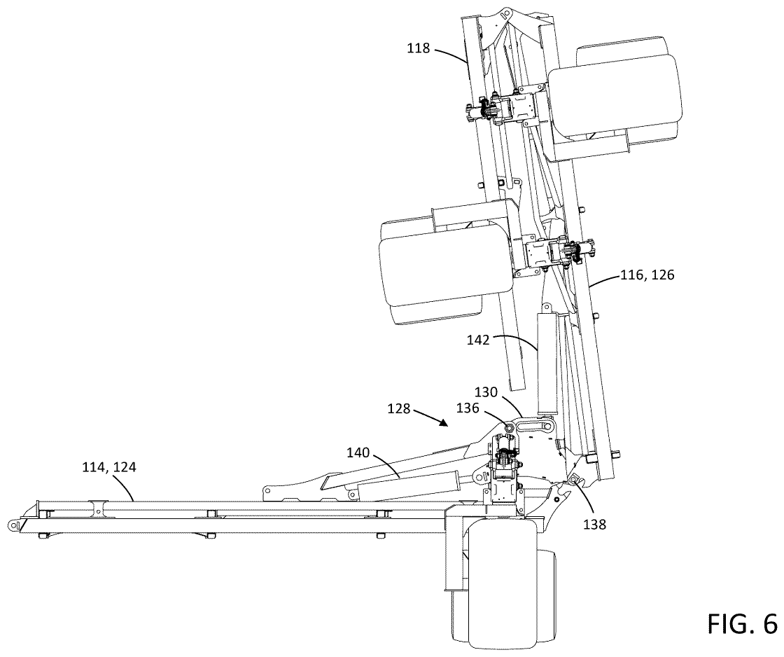

In the example illustrated, the first arm 146 includes a pivot slot 150 and the second arm 148 includes a pivot member 156 secured to the second arm. The isolation joint 144 is movable between a disengaged position (FIGS. 6, 7) and an engaged position (FIGS. 4, 5, 9). In the disengaged position, the pivot member 156 is spaced apart from the pivot slot 150 when the second wing is in the folded position (FIG. 7) to facilitate folding of the implement. In the engaged position, the pivot member 156 is seated in the pivot slot 150 and in coaxial alignment with the field axis when the second wing is in the unfolded position (FIG. 4) to isolate the hinge mechanism 128 from forces urging adjacent portions 145 of the first and second wings 124, 126 laterally toward or apart from one another during use of the implement.

Referring again to FIG. 9, the pivot slot 150 extends between a pivot slot open end 152 and a pivot slot closed end 154. In the example illustrated, the pivot slot open and closed ends 152, 154 are spaced apart from each other along a pivot slot arc 158. The pivot slot arc 158 is concentric with the transport axis 136 when moving the pivot member 156 relative to the pivot slot 150 between the pivot slot open end 152 and the pivot slot closed end 154.

In the example illustrated, the pivot slot 150 has arcuate side walls 160 which are concentric with the pivot slot arc 158 and extend between the pivot slot open end 152 and the pivot slot closed end 154. In other embodiments, the pivot slot 150 may have non-arcuate side walls or straight side walls which extend between the pivot slot open end 152 and the pivot slot closed end 154 and which have a length and/or are spaced apart a sufficient distance so as to avoid interfering with the pivot member 156 when the isolation joint 144 moves between the disengaged position and the engaged position.

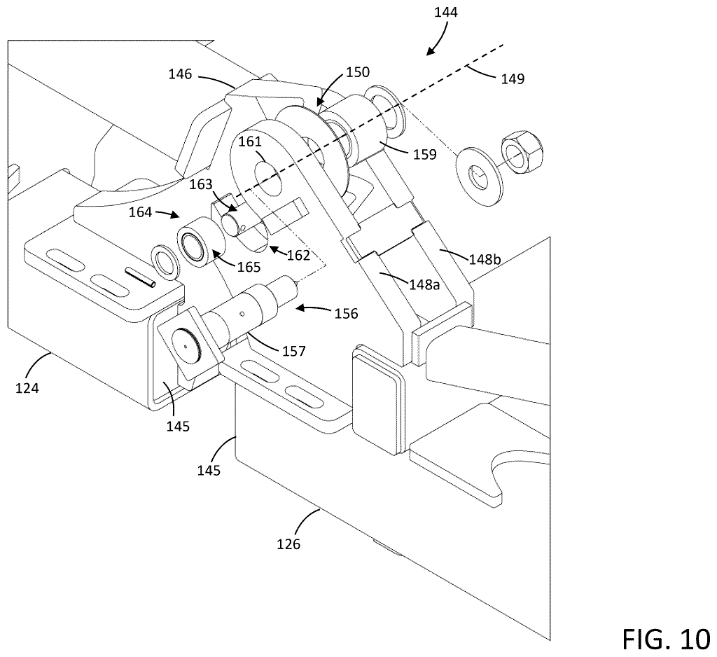

With reference also to FIG. 10, in the example illustrated, the pivot member 156 comprises a pivot axle 157 on which a pivot roller bushing 159 is mounted. In the example illustrated, the second arm 148 is of dual plate construction, having a front plate 148a and a rear plate 148b spaced apart from the front plate by a longitudinal gap. The pivot axle 157 is fixed within opposed mounting apertures 161 in the front and rear plates 148a, 148b, and the pivot roller bushing 159 is rotatably supported on the pivot axle 157, between the front and rear plates 148a, 148b. The pivot roller bushing 159 is sized to provide a snug sliding fit within the pivot slot 150, for smooth engagement and disengagement with the slot and accurate positioning of the second hinge axis 134 (fixed to the second wing 126, in the example illustrated) relative to the first wing 124 when the pivot member 156 is fully seated in the pivot slot 150. The sidewalls of the pivot slot 150 near the open end 152 are, in the examples illustrated, flared outwardly to assist guiding the pivot roller bushing into the pivot slot 150 when moving from the disengaged to the engaged position. In other examples, the pivot member may be any structure which releasably engages the pivot slot 150 such as a fixed pin or a roller bearing.

When in the engaged position, the isolation joint defines an isolation joint pivot axis 149 that facilitates relative pivoting movement between the first wing 124 and the second wing 126 and resists lateral movement of the first and second wings relative to one another. The isolation joint 144 is disengageable to facilitate folding of the second wing 126. More particularly, when moving the second wing 126 from the unfolded position to the folded position, the isolation joint 144 is moved from the engaged position illustrated in FIG. 9, in which the pivot member 156 is seated at the closed end 154 of the pivot slot 150, to the disengaged position illustrated in FIGS. 6 and 7, in which the pivot member 156 is withdrawn from the pivot slot open end 152 and spaced apart from the pivot slot 150. Disengaging the isolation joint 144 facilitates separation of the second arm 148 from the first arm 146 (FIG. 7) as the second wing 126 pivots relative to the first wing 124 during folding. The hinge link 130 is pivotable about the transport axis 136 when the pivot member 156 withdraws from the pivot slot 150, facilitating the movement of the second wing 126 from the unfolded position to the folded position.

Referring to FIG. 3, when seated in the pivot slot 150 and abutting the pivot slot closed end 154, the pivot member 156 defines an isolation joint pivot axis 149 that is in coaxial alignment with the field axis 138. The collinearity of the isolation joint pivot axis and the field axis 138 facilitates pivoting of the second wing 126 about the field axis 138 to follow field contours during operation of the implement. In the engaged position, engagement of the pivot member 156 with the pivot slot closed end 154 can resist or counteract a compressive lateral force urging adjacent portions of the first and second wings 124,126 laterally towards one another during use of the implement. Additionally, engagement of the pivot member 156 with the side walls 160 of the pivot slot 150 can resist or counteract a tensile force urging adjacent portions 145 of the first and second wings 124,126 laterally apart from one another.

When moving the isolation joint 144, in the example illustrated, from the disengaged position to the engaged position during unfolding of the implement, the pivot slot closed end 154 acts as a positive stop for pivoting of the hinge link 130 about the transport axis 136. This prevents further pivoting of the hinge link 130 (and the second wing 126) about the transport axis 136. In such examples, the positive stop action defines the orientation of the hinge link 130 with respect to the first wing 124 when in the unfolded position. This positive stop action, in the example illustrated, helps to achieve accurate colinear alignment of the isolation joint pivot axis 149 with the field axis 138.

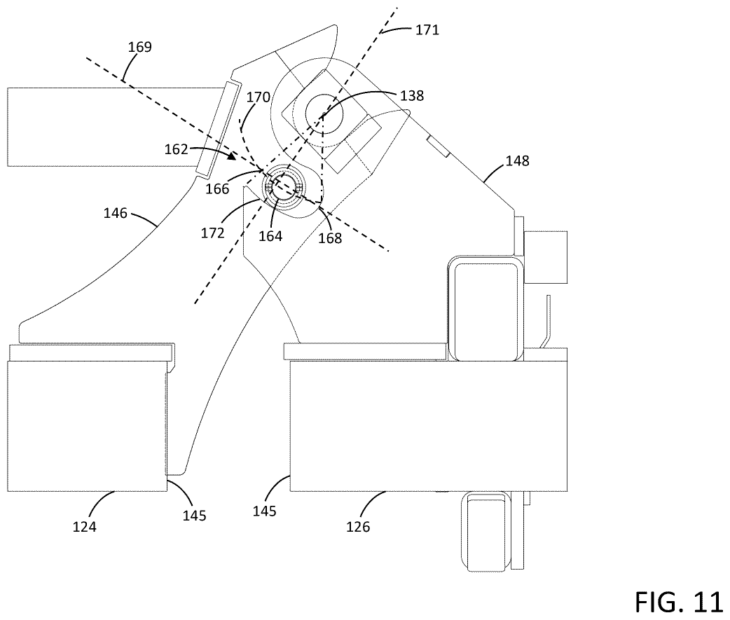

With respect to FIGS. 10 and 11, the isolation joint 144 in the example illustrated includes an optional retaining mechanism that can, among other things, facilitate holding the isolation joint 144 in the engaged position during use of the implement. In the example illustrated, one of the first and second arms 146, 148 includes a retaining slot 162, and another, different one of the first and second arms 146, 148 includes a retaining member 164 secured thereto. More particularly, in the example illustrated, the second arm 148 includes a retaining slot 162 and the first arm 146 includes a corresponding retaining member 164 which is receivable within the retaining slot 162.

The retaining member 164 is movable relative to the retaining slot 162 between a coupled position within the retaining slot and an uncoupled position spaced apart from the retaining slot by pivoting the second wing 126 about the field axis 138. The retaining member 164 is receivable in the retaining slot 162 when the pivot member 156 is seated in the pivot slot 150. When in the coupled position, engagement of the retaining member with a sidewall of the retaining slot contributes to at least one of (i) isolating the hinge mechanism from the lateral forces, and (ii) inhibiting withdrawal of the pivot member 156 from the pivot slot 150.

Referring to FIG. 11, in the example illustrated, the retaining slot 162 extends between a retaining slot open end 166 and a retaining slot closed end 168. The open and closed ends 166, 168 are, in the example illustrated, spaced apart along a retaining slot arc 170. The retaining slot arc 170 is concentric with the field axis 138 when the retaining member 164 is moved relative to the retaining slot 162. In the illustrated example, the retaining slot arc 170 is concentric with the field axis 138 when the second wing 126 is in the unfolded position and the second wing 126 is pivoted about the field axis 138.

The retaining slot 162 has retaining slot side walls 172 extending between the retaining slot open end 166 and the retaining slot closed end 168 and spaced apart from one another by a retaining slot gap for receiving the retaining member 164. In the example illustrated, the retaining slot sidewalls 172 are concentric with the retaining slot arc 170. In other examples, the retaining slot 162 may have non-arcuate side walls or straight side walls which extend between the retaining slot open end 166 and the retaining slot closed end 168 and which have a length and/or are spaced apart a sufficient distance so as to avoid interfering with the retaining member 164 when the retaining member moves between the coupled and uncoupled positions relative to the retaining slot 162.

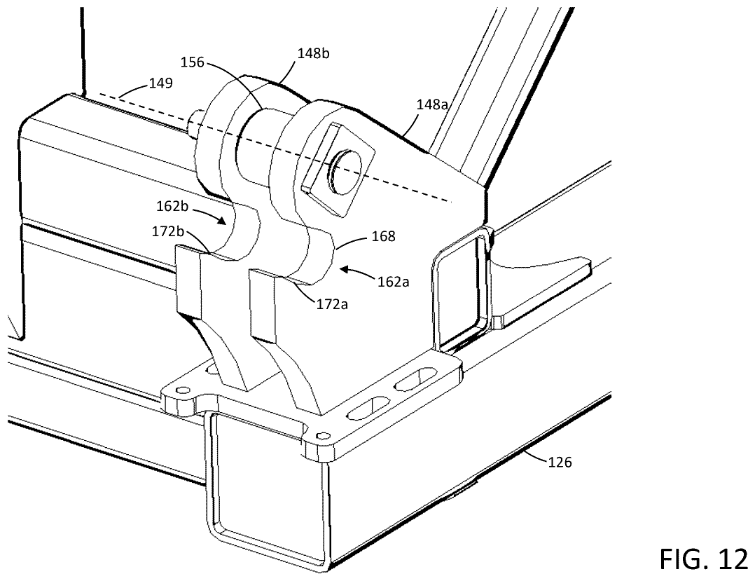

With reference also to FIG. 12, as mentioned previously the second arm 148, in the example illustrated, is of dual plate construction, having a front plate 148a and a rear plate 148b spaced apart from the front plate 148a by a longitudinal gap. The retaining slot 162 includes corresponding front and rear slot portions 162a and 162b in the front and rear plates 148a, 148b, respectively. The front retaining slot portion 162a includes front slot sidewalls 172a in the front plate 148a, and rear retaining slot includes rear slot side walls 172b in the rear plate 148b of the second arm 148.

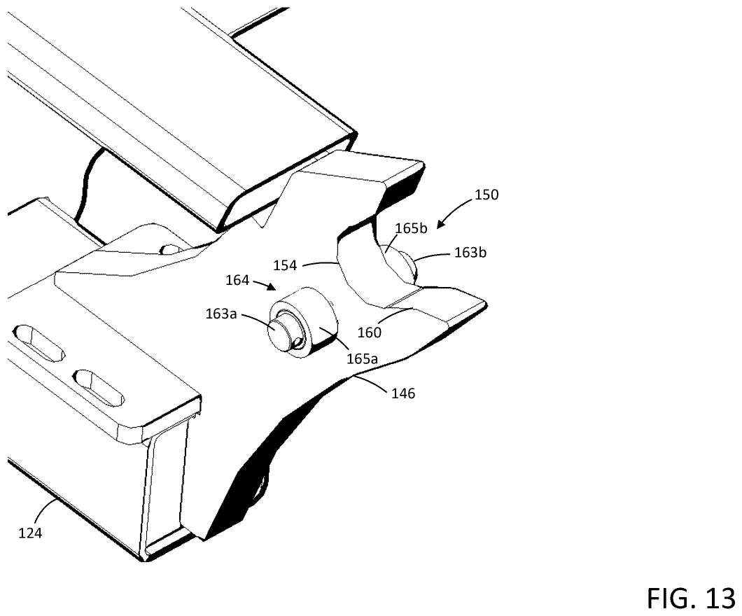

Referring to FIG. 13, the first arm 146 is, in the example illustrated, of single plate construction with the pivot slot sidewalls 160 and the end wall at the pivot slot closed end 154 extending through the thickness of the first arm 146. The thickness of the first arm is sufficiently narrow to fit in the gap between the front and rear plates 148a and 148b of the second arm 148.

The retaining member 164, in the example illustrated, includes a retainer shaft 163 fixed to the first arm 146 at a position set back from the closed end 154 of the pivot slot 150. In the example illustrated, the retaining member 164 further includes a retainer roller bushing 165 mounted to the retainer shaft 163. In the example illustrated, the retainer shaft includes front shaft segment 163a protruding from the forward surface of the first arm 146, and a rear shaft segment 163b protruding from the rear surface of the first arm 146. The retainer roller bushing 165 includes a front roller bushing 165a mounted to the front shaft segment 163a, and a rear roller bushing 165b mounted to the rear shaft segment 163b. The front and rear roller bushings 165a, 165b are positioned for alignment with front and rear slot portions 162a and 162b, respectively, of the front and rear plates 148a, 148b of the second arm 148 when moving between the uncoupled and coupled positions.

Referring again to FIG. 11, in the example illustrated, the retaining slot 162 is oriented generally orthogonal to the pivot slot 150. More particularly, a straight line extending centrally from the closed to open ends 168, 166 of the retaining slot 162 defines a nominal retaining slot axis 169, and a straight line extending centrally through a midpoint of the closed and open ends 154, 152 of the pivot slot 150 defines a nominal pivot slot axis 171. When the implement is in the unfolded position for use, the nominal retaining slot axis 169 and the nominal pivot slot axis 171 are oriented within 30 degrees of perpendicular relative to one another (i.e. in a range of 60 degrees to 120 degrees).

When the retaining member 164 is in the coupled position (received within the retaining slot 162), engagement of the retaining member 164 with the retaining slot side walls 172 (particularly the lower sidewall spaced furthest from pivot member 156) inhibits withdrawal of the pivot member 156 form the pivot slot 150. Additionally or alternatively, engagement of the retaining member 164 with the retaining slot side walls 172 can help to resist forces urging the adjacent portions of the first wing 124 and second wing 126 laterally toward or apart from one another during use of the implement.

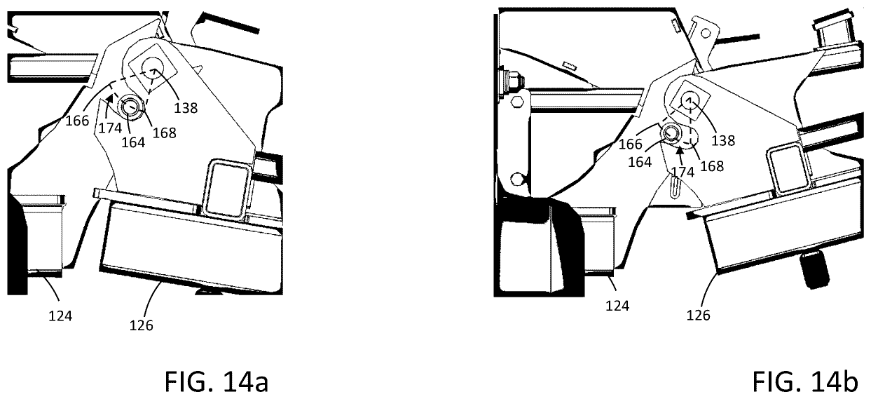

With reference now to FIGS. 14a and 14b, when the second wing 126 is in the unfolded position, the first wing 124 and second wing 126 are pivotable relative to each other about the field axis 138 and the isolation joint pivot axis within a contour pivot range 174 to facilitate engagement of the first wing 124 and second wing 126 with uneven ground surfaces traversed by the implement. In the example illustrated, the contour pivot range 174 corresponds to relative movement of the retaining member in the retaining slot between the retaining slot open end 166 and the retaining slot closed end 168.

In the example illustrated, the first and second wings 124, 126 are parallel to a horizontal plane when the implement traverses flat, even ground. When encountering uneven ground, the second wing can pivot downward relative to the first wing to a point where the retaining member 164 engages the closed end of the retaining slot (FIG. 14a). The second wing can also pivot upward relative to the first wing to a point where the retaining member 164 is at the open end of the retaining slot and still coupled therewith (FIG. 14b). In the example illustrated, the contour pivot range has an angular extent of about 30 degrees about the field axis.

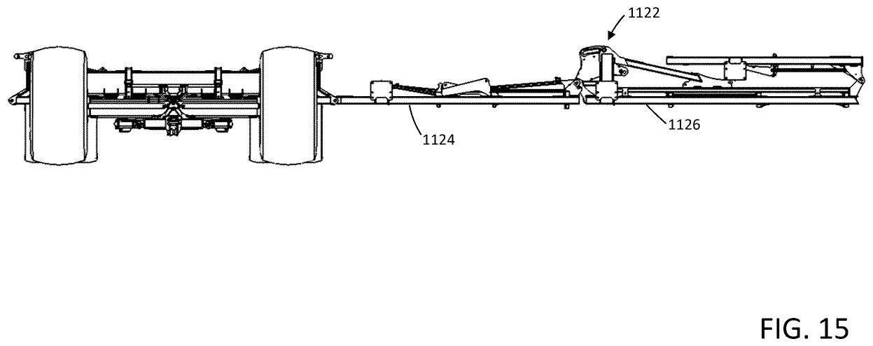

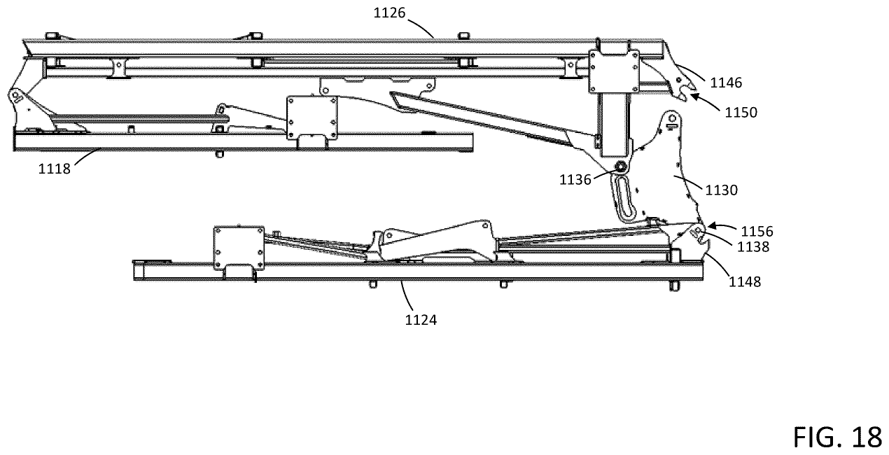

Referring to FIGS. 15 through 18, another example of a connection system 1122 for connecting together a first wing 1124 and a second wing 1126 of a foldable agricultural implement 100 is similar to the connection system 122, with like features identified by like reference characters, incremented by 1000. The connection system 1122 has a hinge mechanism 1128 that includes a hinge link 1130 coupled to the first wing 1124 about a longitudinally extending first hinge axis and coupled to the second wing 1126 about a longitudinally extending second hinge axis. The second wing 1126 is pivotable about the first and second hinge axes for moving the second wing 1126 between an unfolded position illustrated in FIG. 15, in which the second wing 1126 is laterally adjacent the first wing 1124 (the second wing 1126 having an outer wing 1118 folded thereupon), and a folded position, illustrated in FIG. 18, in which the second wing 1126 overlaps the first wing 1124 to facilitate transport of the implement.

In the example illustrated, the first hinge axis is fixed relative to the first wing 1124 and defines a field axis 1138, and the second hinge axis is fixed relative to the second wing 1126 and defines a transport axis 1136. The second wing 1126 is pivotable relative to the first wing 1124 about the field axis 1138 when the second wing 1126 is in the unfolded position and the implement is in use to facilitate following field contours.

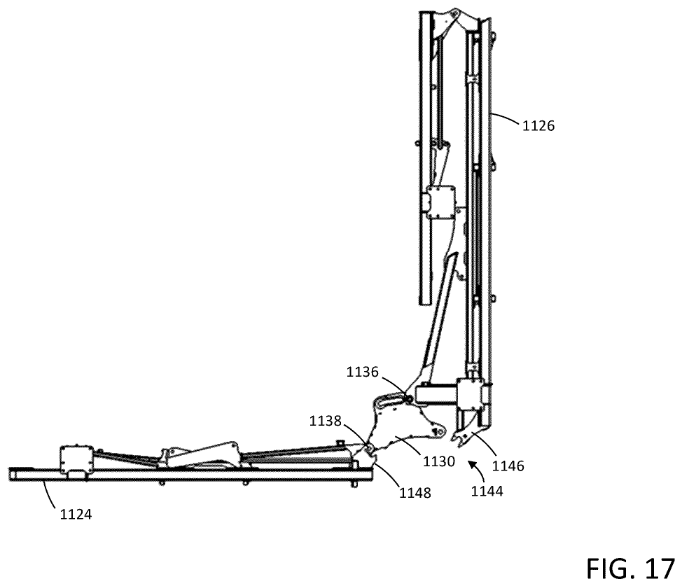

Referring to FIG. 17, the connection system 1122 further includes an isolation joint 1144. The isolation joint includes a first arm 1146 fixed to one of the first wing and the second wing, and a second arm 1148 fixed to an other, different one of the first wing and the second wing such that each of the first wing and the second wing has one of the first arm and the second arm fixed thereto. In the example illustrated, the first arm 1146 is fixed to the second wing 1126 and the second arm 1148 is fixed to the first wing 1124. The first arm 1146 includes a pivot slot 1150, and the second arm includes a pivot member 1156 secured to the second arm.

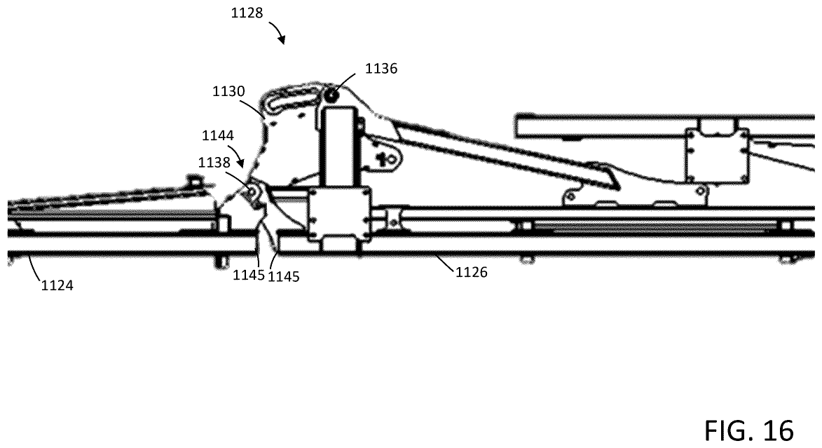

The isolation joint is movable between a disengaged position (illustrated in FIGS. 17 and 18) in which the pivot member 1156 is spaced apart from the pivot slot 1150 when the second wing is in the folded position to facilitate folding of the implement, and an engaged position (illustrated in FIGS. 15 and 16) in which the pivot member 1156 is seated in the pivot slot 1150 and in coaxial alignment with the field axis 1138 when the second wing 1126 is in the unfolded position to isolate the hinge mechanism 1128 from forces urging adjacent portions 1145 of the first and second wings 1124, 1126 laterally toward or apart from one another during use of the implement.

Referring to FIGS. 17 and 18, when moving from the unfolded position to the folded position, in the example illustrated, the second wing 1126 first pivots about the transport axis 1136 to move to the intermediate, partly-folded position (FIG. 17). The hinge link 1130 and second wing 1126 is then pivoted about the field axis 1138 to move the second wing to the folded position. The outer wing 1118 is, in the example illustrated, sandwiched between the inner wing 1124 and the outer wing 1126 when the outer wing 1126 is in the folded position (FIG. 18).

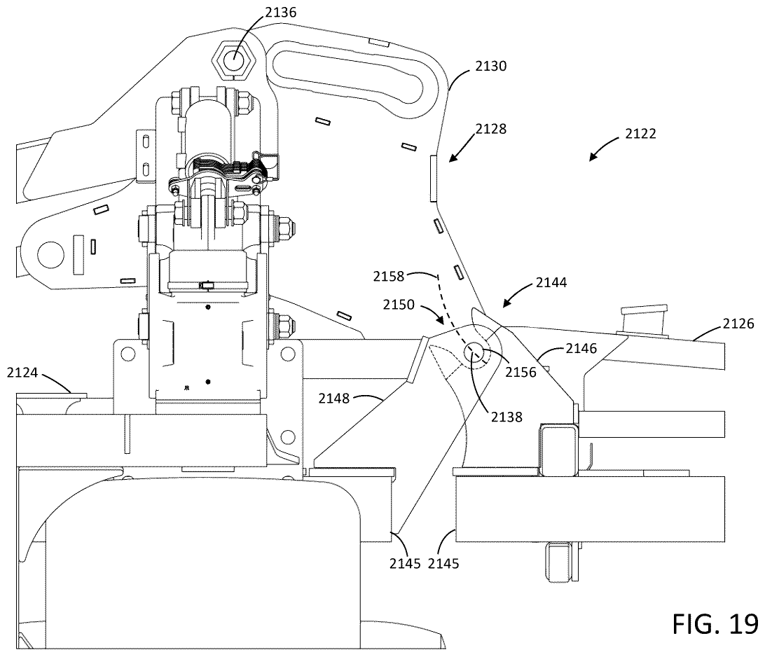

Referring to FIG. 19, another example connection system 2122 for connecting together a first wing 2124 and a second wing 2126 of a foldable agricultural implement 100 is similar to the connection system 122, with like features identified by like reference characters, incremented by 2000. The connection system 2122 has a hinge mechanism 2128 that includes a hinge link 2130 coupled to the first wing 2124 about a longitudinally extending first hinge axis and coupled to the second wing 2126 about a longitudinally extending second hinge axis. The second wing 2126 is pivotable about the first and second hinge axes for moving the second wing 2126 between an unfolded position in which the second wing 2126 is laterally adjacent the first wing 2124 for use of the implement, and a folded position in which the second wing 2126 overlaps the first wing 2124 to facilitate transport of the implement.

In the example illustrated, the first hinge axis is fixed relative to the first wing 2124 and defines a transport axis 2136, and the second hinge axis is fixed to the second wing 2126 and defines a field axis 2138. The second wing 2126 is pivotable relative to the first wing 2124 about the field axis 2138 when the second wing 2126 is in the unfolded position and the implement is in use to facilitate following field contours.

The connection system 2122 further includes an isolation joint 2144. The isolation joint includes a first arm 2146 fixed to one of the first wing and the second wing, and a second arm 2148 fixed to an other, different one of the first wing and the second wing such that each of the first wing and the second wing has one of the first arm and the second arm fixed thereto. In the example illustrated, the first arm 2146 is fixed to the second wing 2126 and the second arm 2148 is fixed to the first wing 2124. The first arm 2146 includes a pivot slot 2150, and the second arm 2148 includes a pivot member 2156 secured to the second arm 2148. Accordingly, in the example illustrated, the transport axis 2136 and the pivot slot 2150 are fixed to different wings 2124, 2126, i.e. fixed to the first wing 2124 and to the second wing 2126, respectively.

The isolation joint 2144 is movable between a disengaged position in which the pivot member 2156 is spaced apart from the pivot slot 2150 when the second wing 2126 is in the folded position to facilitate folding of the implement, and an engaged position (FIG. 19) in which the pivot member 2156 is seated in the pivot slot 2150 and in coaxial alignment with the field axis 2138 when the second wing 2126 is in the unfolded position to isolate the hinge mechanism 2128 from forces urging adjacent portions 2145 of the first and second wings 2124, 2126 laterally toward or apart from one another during use of the implement.

In the illustrated example, the pivot slot arc 2158 is non-concentric with the transport axis 2136 when the second wing 2126 is in the unfolded position relative to the first wing 2124. Moving the second wing 2126 of connection system 2122 from the unfolded position to the folded position includes, in the example illustrated, pivoting the second wing about the field axis 2138 to an intermediate position (orienting the second wing 2126 generally upright in the example illustrated, perpendicular to the first wing 2124). This moves the origin or axis of the pivot slot arc 2158 so that the arc 2158 is concentric with the transport axis 2136 when the second wing 2126 has been pivoted about the field axis 2138 to the intermediate position. The second wing 2126 may then be moved from the intermediate position to the folded position by pivoting the hinge link 2130 and second wing 2126 about the transport axis 2136, withdrawing the pivot member 2156 from the pivot slot 2150 and thus disengaging the isolation joint.

In the example illustrated, the isolation joint 2144 is free of features of a retaining mechanism, such as the retaining slot 162 and retaining member 164 of the isolation joint 144.

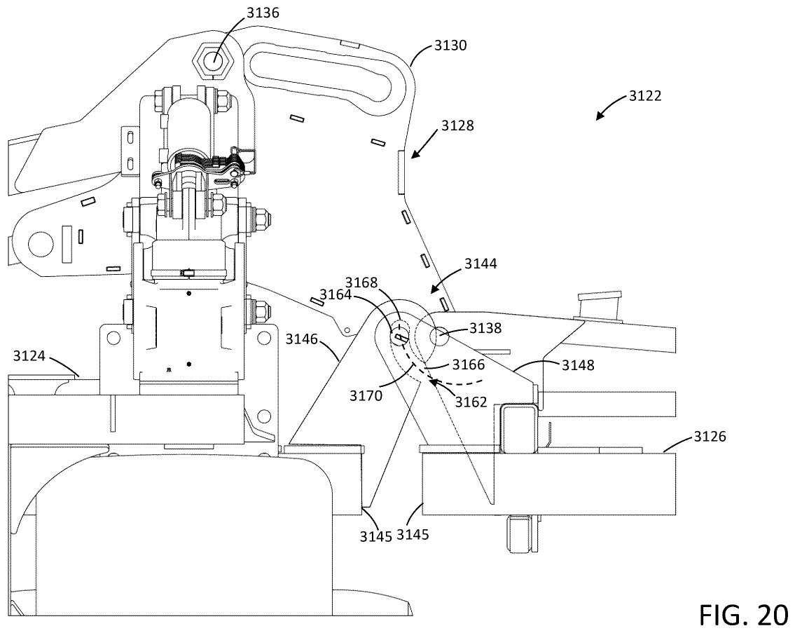

Referring to FIG. 20, another example connection system 3122 for connecting together a first wing 3124 and a second wing 3126 of a foldable agricultural implement 100 is similar to the connection system 122, with like features identified by like reference characters, incremented by 3000.

The connection system 3122 has a hinge mechanism 3128 including a hinge link 3130 coupled to the first wing 3124 about a longitudinally extending first hinge axis and coupled to the second wing about a longitudinally extending second hinge axis. The second wing 3126 is pivotable about the first and second hinge axes for moving between an unfolded position as illustrated in FIG. 20, in which the second wing 3126 is laterally adjacent the first wing 3124 for use of the implement, and a folded position in which the second wing 3126 overlaps the first wing 3124 to facilitate transport of the implement. One of the first hinge axis and the second hinge axis defines a transport axis 3136 and another, different one of the first hinge axis and the second hinge axis defines a field axis 3138. In the example illustrated, the first hinge axis is fixed relative to the first wing 3124 and defines the transport axis 3136, and the second hinge axis is fixed relative to the second wing 2126 and defines the field axis 3138. The second wing 3126 is pivotable relative to the first wing 3124 about the field axis 3138 when the second wing 3126 is in the unfolded position and the implement is in use to facilitate following field contours.

The connection system 3122 further includes an isolation joint 3144 including a first arm 3146 fixed to one of the first wing 3124 and the second wing 3126, and a second arm 3148 fixed to an other, different one of the first wing 3124 and the second wing 3126 such that each of the first wing 3124 and the second wing 3126 has one of the first arm 3146 and the second arm 3148 fixed thereto. In the example illustrated, the first arm 3146 is fixed to the first wing 3124 and the second arm 3148 is fixed to the second wing 3126.

The first arm 3146 includes a retaining slot 3162, and the second arm 3148 includes a retaining member 3164 secured to the second arm 3148. The isolation joint 3144 is movable between a disengaged position in which the retaining member 3164 is spaced apart from the retaining slot 3162 when the second wing 3126 is in the folded position to facilitate folding of the implement, and an engaged position (illustrated in FIG. 20) in which the retaining member 3164 is disposed within the retaining slot 3162 when the second wing 3126 is in the unfolded position to isolate the hinge mechanism 3128 from forces urging adjacent portions 3145 of the first and second wings 3124,3126 laterally toward or apart from one another during use of the implement.

In the example illustrated, the retaining slot 3162 extends between a retaining slot open end 3166 and a retaining slot closed end 3168, the retaining slot open and closed ends spaced apart along a retaining slot arc 3170 that is concentric with the field axis 3138 when moving the retaining member 3164 relative to the retaining slot 3162 between the retaining slot open and closed ends 3166,3168.

In the example illustrated, when the implement is unfolded for use, pivoting of the second wing 3126 relative to the first wing 3124 about the field axis 3138 within a contour pivot range corresponds to relative movement of the retaining member 3164 in the retaining slot 3162 between the retaining slot open end 3166 and the retaining slot closed end 3168.

When the second wing 3126 is in the unfolded position, the first wing 3124 and the second wing 3126 are pivotable relative to each other about the field axis 3138 within the contour pivot range extending between the retaining slot closed end 3168 and the retaining slot open end 3166, to move between a second wing orientation that is slightly below horizontal and a second wing position that is slightly above horizontal. The retaining slot closed end 3168 may act as a positive stop for the second wing 3126 when pivoting about the field axis 3138. The positive stop may define the lowest orientation of the second wing 3126 with respect to the first wing 3124 within the contour pivot range.

In the illustrated example, the retaining slot arc 3170 is non-concentric with the transport axis 3136. Moving the second wing 3126 of connection system 3122 from the unfolded position to the folded position includes, in the example illustrated, pivoting the second wing about the field axis 3138 to an intermediate position (orienting the second wing 3126 generally upright in the example illustrated, perpendicular to the first wing 3124). This moves the retaining member 3164 from the engaged position to the disengaged position in which the retaining member 3164 is spaced apart from the retaining slot 3162 when the second wing 3126 has been pivoted about the field axis 3138 to the intermediate position. The second wing 3126 may then be moved from the intermediate position to the folded position by pivoting the hinge link 3130 and second wing 3126 about the transport axis 3136.

In the example illustrated, the isolation joint 3144 is free of (or omits) some of the features of other isolation joints disclosed herein, such as the pivot slot 150 and the pivot member 156 of the isolation joint 144. This can provide certain benefits, such as reduced cost and improved simplicity of manufacture and operation.

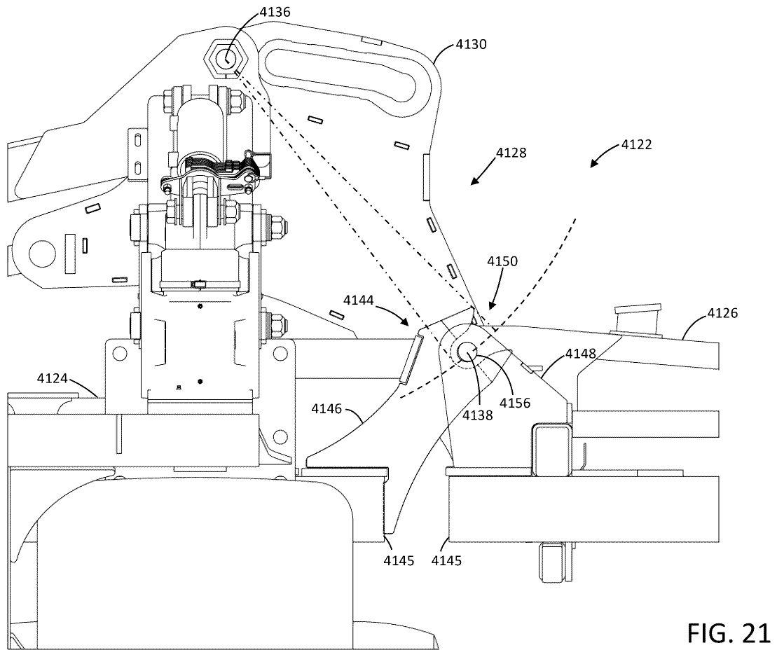

Referring to FIG. 21, another example of a connection system 4122 for connecting together a first wing 4124 and a second wing 4126 of a foldable agricultural implement 100 is similar to the connection system 122, with like features identified by like reference characters, incremented by 4000. The connection system 4122 has a hinge mechanism 4128 that includes a hinge link 4130 coupled to the first wing 4124 about a longitudinally extending first hinge axis and coupled to the second wing 4126 about a longitudinally extending second hinge axis. The second wing 4126 is pivotable about the first and second hinge axes for moving the second wing 4126 between an unfolded position illustrated in FIG. 21, in which the second wing 4126 is laterally adjacent the first wing 4124, and a folded position, in which the second wing 4126 overlaps the first wing 4124 to facilitate transport of the implement.

One of the first hinge axis and the second hinge axis defines a transport axis 4136 and another, different one of the first hinge axis and the second hinge axis defines a field axis 4138. In the example illustrated, the first hinge axis is fixed relative to the first wing 4124 and defines the transport axis 4136, and the second hinge axis is fixed relative to the second wing 4126 and defines the field axis 4138. The second wing 4126 is pivotable relative to the first wing 4124 about the field axis 4138 when the second wing 4126 is in the unfolded position and the implement is in use to facilitate following field contours.

The connection system 4122 further includes an isolation joint 4144. The isolation joint includes a first arm 4146 fixed to one of the first wing and the second wing, and a second arm 4148 fixed to an other, different one of the first wing and the second wing such that each of the first wing and the second wing has one of the first arm and the second arm fixed thereto. In the example illustrated, the first arm 4146 is fixed to the first wing 4124 and the second arm 4148 is fixed to the second wing 4126. The first arm 4146 includes a pivot slot 4150, and the second arm 4148 includes a pivot member 4156 secured to the second arm.

The isolation joint 4144 is movable between a disengaged position in which the pivot member 4156 is spaced apart from the pivot slot 4150 when the second wing is in the folded position to facilitate folding of the implement, and an engaged position (illustrated in FIG. 21) in which the pivot member 4156 is seated in the pivot slot 4150 and in coaxial alignment with the field axis 4138 when the second wing 4126 is in the unfolded position to isolate the hinge mechanism 4128 from forces urging adjacent portions 4145 of the first and second wings 4124, 4126 laterally toward or apart from one another during use of the implement.

In the example illustrated, the isolation joint 4144 is free of some of the features of other isolation joints disclosed herein, such as the optional retaining slot 162 and retaining member 164 of the isolation joint 144. This can provide certain benefits, such as reduced cost and improved simplicity of manufacture and operation.

What has been described above is intended to be illustrative of examples of the teaching disclosed herein, without limiting the scope of patent claims granted herefrom. The scope of such claims should be given the broadest interpretation consistent with the description as a whole.

1. A connection system for connecting together a first wing and a second wing of a foldable agricultural implement, the connection system comprising:
a) a hinge mechanism including a hinge link coupled to the first wing about a longitudinally extending first hinge axis and coupled to the second wing about a longitudinally extending second hinge axis, the second wing pivotable about the first and second hinge axes for moving the second wing between an unfolded position in which the second wing is laterally adjacent the first wing for use of the implement, and a folded position in which the second wing overlaps the first wing to facilitate transport of the implement, wherein one of the first hinge axis and the second hinge axis defines a field axis and another, different one of the first hinge axis and the second hinge axis defines a transport axis, wherein the second wing is pivotable relative to the first wing about the field axis when the second wing is in the unfolded position and the implement is in use to facilitate following field contours; and
b) an isolation joint including a first arm fixed to one of the first wing and the second wing, and a second arm fixed to an other, different one of the first wing and the second wing such that each of the first wing and the second wing has one of the first arm and the second arm fixed thereto, wherein the first arm includes a pivot slot, and the second arm includes a pivot member secured to the second arm, and wherein the isolation joint is movable between a disengaged position in which the pivot member is spaced apart from the pivot slot when the second wing is in the folded position to facilitate folding of the implement, and an engaged position in which the pivot member is seated in the pivot slot and in coaxial alignment with the field axis when the second wing is in the unfolded position to isolate the hinge mechanism from forces urging adjacent portions of the first and second wings laterally toward or apart from one another during use of the implement.

2. The connection system of claim 1, wherein the first hinge axis is fixed relative to the first wing.

3. The connection system of claim 1, wherein the second hinge axis is fixed relative to the second wing.

4. The connection system of claim 1, wherein the pivot slot extends between a pivot slot open end and a pivot slot closed end, the pivot slot open and closed ends spaced apart along a pivot slot arc that is concentric with the transport axis when moving the pivot member relative to the pivot slot between the pivot slot open and closed ends.

5. The connection system of claim 4, wherein the first arm is fixed to the first wing and the second arm is fixed to the second wing.

6. The connection system of claim 5, wherein the pivot slot is fixed relative to the field axis, and the pivot member is receivable in the pivot slot when the second wing is moved from the folded position to the unfolded position.

7. The connection system of claim 1, wherein one of the first and second arms further includes a retaining slot, and another, different one of the first and second arms includes a retaining member secured thereto, the retaining member receivable in the retaining slot when the pivot member is seated in the pivot slot, wherein engagement of the retaining member with a sidewall of the retaining slot contributes to at least one of (i) said isolating of the hinge mechanism from said forces, and (ii) inhibiting withdrawal of the pivot member from the pivot slot.

8. The connection system of claim 7, wherein when the pivot member is in the engaged position, the retaining member is movable relative to the retaining slot between a coupled position within the retaining slot and an uncoupled position spaced apart from the retaining slot by pivoting the second wing about the field axis.

9. The connection system of claim 8, wherein the retaining slot extends between a retaining slot open end and a retaining slot closed end, the retaining slot open and closed ends spaced apart along a retaining slot arc that is concentric with the field axis when moving the retaining member relative to the retaining slot between the retaining slot open and closed ends.

10. The connection system of claim 9, wherein the second arm comprises the retaining slot, and the first arm comprises the retaining member secured thereto.

11. The connection system of claim 7, wherein when the implement is unfolded for use, pivoting of the second wing relative to the first wing about the field axis within a contour pivot range corresponds to relative movement of the retaining member in the retaining slot between the retaining slot open end and the retaining slot closed end.

12. The connection system of claim 1, wherein the pivot member, when in the engaged position, defines an isolation joint pivot axis that is colinear with the field pivot axis.

13. The connection system of claim 1, wherein the second wing is pivotable about the field axis by about 90 degrees.

14. The connection system of claim 1, wherein the hinge link is pivotable about the transport axis by about 90 degrees.

15. The connection system of claim 1, comprising two said isolation joints spaced longitudinally apart from one another, including a front isolation joint proximate a front of the first and second wings, and a rear isolation joint proximate a rear of the first and second wings.

16. The connection system of claim 15, comprising two said hinge mechanisms spaced longitudinally apart from one another.

17. The connection system of claim 16, wherein the two hinge mechanisms are disposed longitudinally between the front and rear isolation joints.

18. A connection system for connecting together a first wing and a second wing of a foldable agricultural implement, the connection system comprising:
a) a hinge mechanism including a hinge link coupled to the first wing about a longitudinally extending first hinge axis and coupled to the second wing about a longitudinally extending second hinge axis, the second wing pivotable about the first and second hinge axes for moving between an unfolded position in which the second wing is laterally adjacent the first wing for use of the implement, and a folded position in which the second wing overlaps the first wing to facilitate transport of the implement, wherein one of the first hinge axis and the second hinge axis defines a field axis and another, different one of the first hinge axis and the second hinge axis defines a transport axis, wherein the second wing is pivotable relative to the first wing about the field axis when the second wing is in the unfolded position and the implement is in use to facilitate following field contours; and
b) an isolation joint including a first arm fixed to one of the first wing and the second wing, and a second arm fixed to an other, different one of the first wing and the second wing such that each of the first wing and the second wing has one of the first arm and the second arm fixed thereto, wherein the first arm includes a retaining slot, and the second arm includes a retaining member secured to the second arm, and wherein the isolation joint is movable between a disengaged position in which the retaining member is spaced apart from the retaining slot when the second wing is in the folded position to facilitate folding of the implement, and an engaged position in which the retaining member is disposed within the retaining slot when the second wing is in the unfolded position to isolate the hinge mechanism from forces urging adjacent portions of the first and second wings laterally toward or apart from one another during use of the implement.

19. The connection system of claim 18, wherein the retaining slot extends between a retaining slot open end and a retaining slot closed end, the retaining slot open and closed ends spaced apart along a retaining slot arc that is concentric with the field axis when moving the retaining member relative to the retaining slot between the retaining slot open and closed ends.

20. The connection system of claim 19, wherein when the implement is unfolded for use, pivoting of the second wing relative to the first wing about the field axis within a contour pivot range corresponds to relative movement of the retaining member in the retaining slot between the retaining slot open end and the retaining slot closed end.
